(19) United States
(12) Patent Application Publication
(10) Pub. No.: US 2004/0131413 A1
(43) Pub. Date: Jul. 8, 2004

(54) Ball pusher for applicator tip and point assembly incorporating a ball pusher

(76) Inventor: Alain Rosenzweig, Saint Maur Des Fosses (FR)

Correspondence Address: JONES DAY, 222 EAST 41ST ST, NEW YORK, NY, 10017, US

(21) Appl. No.: 10/698,973

(22) Filed: Oct. 29, 2003

Related U.S. Application Data
(63) Continuation of application No. PCT/FR03/01360, filed on Apr. 30, 2003.

(30) Foreign Application Priority Data
Apr. 30, 2002 (FR) 02 05450

(51) Int. Cl. B43K 7/10

(52) U.S. Cl. 401/214; 401/209

(57) ABSTRACT

The point assembly of the invention includes a housing with a tip end opening and housing a ball adapted to close the opening, a biasing element for biasing the ball and towards the opening a ball pusher positioned between the biasing element and the ball and including a support element and a contact element, the support element having rear and front faces, the contact element extending from the front face, and the rear face facing the biasing element, and the support element having a cross-sectional dimension larger than that of the contact element and being not in lateral contact with the biasing element. Application in particular to writing instruments.

### CROSS-REFERENCE TO RELATED APPLICATIONS

This application is a continuation of PCT Application No. PCT/FR03/01360, filed on Apr. 30, 2003, which claims priority to French Patent Application 0205450, filed Apr. 30, 2002. The entire contents of these two applications is expressly incorporated herein by reference.

### FIELD OF THE INVENTION

The present invention relates generally to an applicator, such as a writing instrument. In particular, the present invention relates to a point assembly that includes a tip ball pusher for positioning in the point assembly for biasing the tip ball of an applicator to substantially close the tip during non-use and to allow fluid to flow from the tip around the tip ball during use.

### BACKGROUND OF THE INVENTION

Conventional ball-point applicators, such as writing instruments, include a ball positioned in the tip of the applicator point. The point may be deformed to prevent the tip ball from falling out. The tip ball may be biased by a spring, which pushes the tip ball against the opening in the point during non-use. It is desirable to bias the tip ball against the opening of the point in order to reduce or to prevent air from coming into contact with the internal workings of the applicator and in order to reduce the leaking of fluid. Also, if the fluid is volatile, an open tip can also allow fluid to evaporate, resulting in a wasting of the fluid in the applicator. During use, the force of writing pushes the tip ball out of contact with the tip opening against the force of the biasing spring. This allows ink to be discharged and to flow around the tip ball to be deposited on or transferred to a surface.

Many techniques are known for biasing tip balls of applicators. For instance, EP 0858911 A1 discloses a writing instrument having a point assembly in which a rotary element, or ball, is positioned in the tip of the pen. The ball is biased into contact with an inward front-end edge of the tip of the pen by a coil spring. The spring directly abuts the ball. In this type of point assembly, the rotation of the ball may be disturbed by friction or scratching of the spring on the tip ball.

U.S. Pat. No. 5,277,510 to Okamoto et al. discloses a correction fluid applicator that utilizes a ball positioned in the recess of a point assembly of the applicator. A movable piece abuts the ball on one end and is associated with a spring on the other end. The movable piece includes a stem that directly contacts the ball and a flange that abuts the spring that biases the movable piece against the ball. In one embodiment, the movable piece includes a long stem that has a portion extending out of the point assembly and into the holder of the applicator. The stem has a varying cross-section, with a smaller cross-section portion contacting the tip ball. In another embodiment, the movable piece is positioned in the point assembly and includes a stem that directly abuts the ball and a flange for adjoining with the spring. The spring extends from the point assembly into the holder. In this embodiment, the stem has a substantially constant diameter and the flange is cylindrical. The flange has a smaller diameter than the internal chamber of the point assembly so that ink may flow around the movable piece. One possible drawback of such dimension is that the movable piece may move laterally and thus is not very stable. The flange also includes a protrusion for extending into and joining with the spring. One possible drawback of the movable piece extending into the spring is that lateral movement of the movable piece (upon rotation of the tip ball) may be imparted to the spring, resulting in internal instability and uneven wear. Moreover, the movable piece and spring must be selected to fit together, thus reducing interchangeability of parts and possibly increasing manufacturing costs.

U.S. Pat. No. 5,516,223 to Matz et al. discloses a correction fluid applicator that includes a socket member positioned between the spring and the tip ball in a point assembly of the applicator. The socket member has a plurality of axial ribs extending from both sides of the member. The ribs contact the ball on one side and the spring on the other.

U.S. Pat. No. 2,719,314 to Taube discloses a perfume dispenser that utilizes a tip ball and includes a fixed resilient partition between the tip ball and a spring. U.S. Pat. No. 5,810,495 to McAuley discloses a liquid applicator for dispensing high volatility, low viscosity liquids. It utilizes a tip ball that is biased by a valve plug that is integrally formed to include a spring-like shape which aids with its resiliency. U.S. Pat. No. 3,523,628 to Colvin et al. describes a dispenser for applying adhesive. This dispenser utilizes a tip ball that is biased by a valve member, similar to that disclosed in U.S. Pat. No. 5,810,495. The valve member is integrally formed to include a spring-like shape which aids with its resiliency.

European patent application EP810103 discloses a writing instrument ball pusher, the pusher comprising a portion in contact with the ball and a rearward surface provided with rib-like fins and large cut-out portions allowing the flow of ink. Only the issue of ink flow and leakage is dealt with, and the issues of reduction of scratching of the ball and motion of the pusher and movable element are not mentioned.

There is a desire to improve upon previously known techniques for biasing a tip ball of a writing instrument or other applicator.

### SUMMARY OF THE INVENTION

One embodiment of the invention relates to a point assembly for an applicator, such as a writing instrument, having a housing with a tip end. The tip end has a tip opening and a back end. A tip ball is positioned in the tip end of the housing and sized to close the tip opening when positioned against the tip opening. A biasing element biases the tip ball toward the tip opening. A ball pusher is positioned between the biasing element and the tip ball. The ball pusher includes a support element and a contact element extending from the support element. The support element has a front face facing the tip ball (and from which the contact element extends), and a rear face facing the biasing element. The support element does not contact the biasing element in a lateral direction so that lateral motion imparted to the ball pusher upon rotation of the tip ball is not also imparted to the biasing element (at least not to as significant an extent as in the prior art). The support element preferably includes at least one cut-out portion extending therethrough between the front face and the rear face of the support element for allowing a substance to flow through the cut-out portions for exit through the tip opening. Furthermore, the contact element has a diameter less than the diameter of the support element.

The contact element may extend outwardly from a center portion of the front face of the support element. Also, the contact element of the ball pusher may be formed integrally with the support element of the ball pusher.

In another embodiment, the housing of the point assembly has an inner barrel having a varied cross-sectional shape. The inner barrel has at least a front portion, a middle portion, and a rear portion. The front portion is substantially ball-shaped and includes a passageway to the middle portion. The middle portion is outwardly cone-shaped with a narrow section adjacent the front portion and a wide section associated with the rear portion. The rear portion is substantially cylindrical. The tip ball is positioned in the front portion, the biasing element and support element are positioned in the rear portion, and the contact element extends through the middle portion to meet the tip ball positioned in the front portion.

The invention also relates to a ball pusher for positioning in the point assembly of an applicator. The point assembly has a tip opening in which a tip ball is positioned. The tip ball is biased against the tip opening by a biasing element. The ball pusher includes a support element having a front face and a rear face. The rear face of the support element is configured for association with the biasing element yet does not contact the biasing element in a lateral direction. The support element has at least one cut-out portion extending from the front face to the rear face. The contact element extends outwardly from the front face of the support element and is configured for contacting the tip ball positioned at the tip opening and for pushing the tip ball against the tip opening. The support element has a diameter less than a diameter of the contact element.

The support element of the ball pusher may be configured and dimensioned to be slidably guided within a barrel of the point assembly. Moreover, the support element may be substantially cylindrical and the barrel may have a substantially cylindrical interior wall. The diameter of the support element is selected to allow the support element to slide within the cylindrical wall of the barrel without significant lateral movement. Also, the contact element may have a smaller cross-sectional dimension than the cross-sectional dimension of the support element. The contact element may be substantially cylindrical or may be formed integrally with the support element.

### BRIEF DESCRIPTION OF THE DRAWINGS

Features of embodiments of the present invention will be apparent from the following disclosure along with the drawings, wherein:

FIG. 1 is a perspective view of a ball pusher according to the principles of the present invention for use in a point assembly of a writing instrument;

FIG. 2 is a cut-away perspective view of a point assembly formed in accordance with the principles of the present invention, showing the components of a system for biasing a tip ball of a writing instrument, including the ball pusher of FIG. 1; and

FIG. 3 is cut-away perspective view of the point assembly of FIG. 2 showing the tip of the point assembly in greater detail.

### DETAILED DESCRIPTION OF THE INVENTION

The present invention relates to a point assembly of an applicator, typically a fluid applicator. While the present invention is useful with any type of applicator that utilizes a ball in the point of the applicator, for the sake of simplicity, the discussion below will relate to the use of the present invention in the point assembly of a writing instrument as in the illustrative embodiment of the figures, such as a gel ink pen in which the present invention is particularly well-suited, mainly because it can be easily added to a standard existing gel ink point assembly. The present invention, however, is not limited to a point assembly for a pen.

The invention relates to an intermediate part positioned in the point assembly of an applicator between the ball positioned in the point of the applicator (hereinafter “tip ball”) and a biasing element, which biases the tip ball into the tip opening of the point assembly. The following disclosure depicts this spring as a coil spring. However, other types of biasing elements or springs are believed to be useful with the present invention, the invention not being so limited. The intermediate part, also referred to herein as a “pusher” or “ball pusher,” is utilized, inter alia, for providing a low friction surface upon which the tip ball can rotate against the biasing force of the spring.

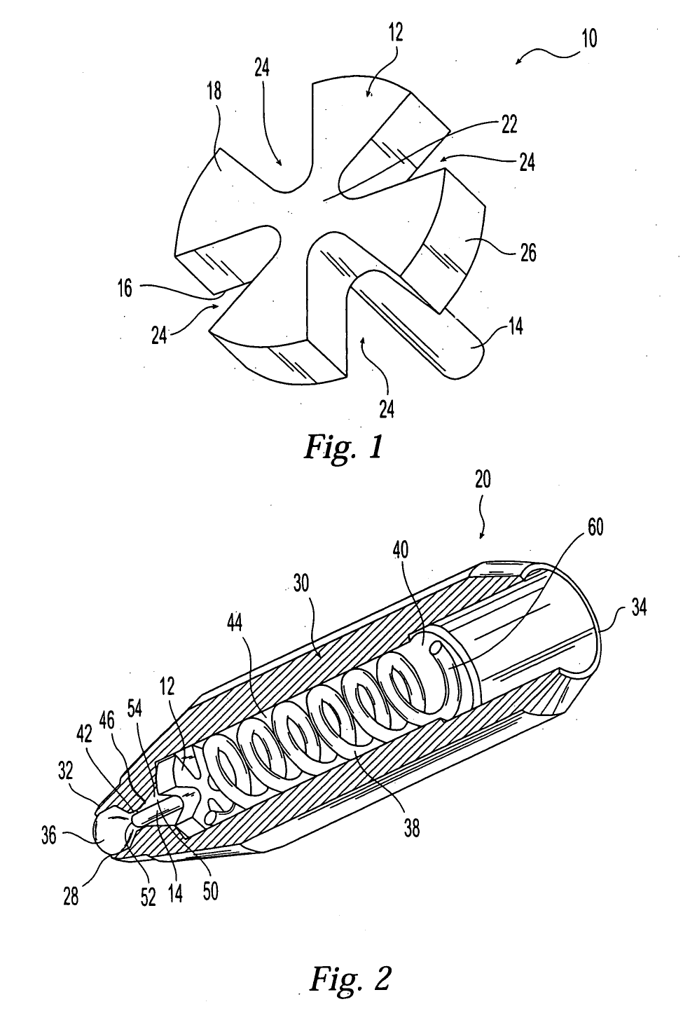

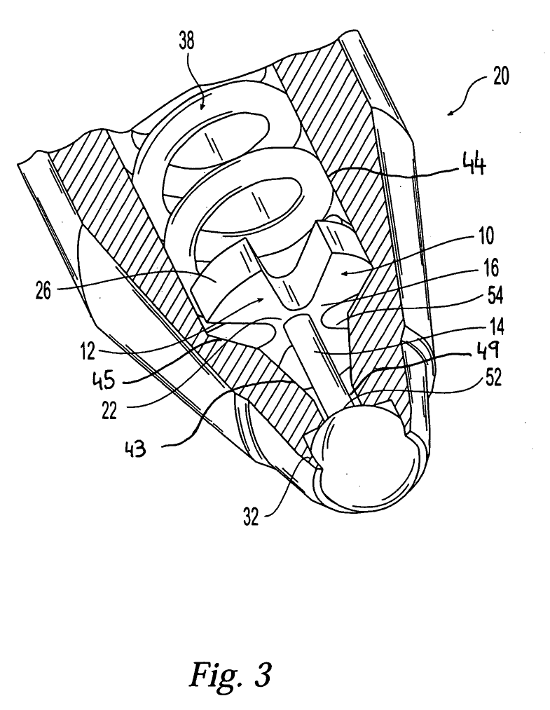

Referring to FIG. 1, a ball pusher 10 is depicted. The ball pusher is for seating in a point assembly 20 of an applicator, such as a pen, as shown in FIGS. 2 and 3. The ball pusher 10 is located between a tip ball 36 and a biasing element 38. The point assembly 20 of the invention may be used with any type of applicator, the type of applicator and the inner workings of the applicator not being critical to the invention. Because the ball pusher and biasing element are both located in the point assembly, assembly of a refill is much easier as the housing of the point assembly serves to contain all elements therein.

Referring to FIG. 1, ball pusher 10 includes a support element 12 that is connected to a contact element 14. Support element 12 is preferably substantially planar (disk-shaped in FIG. 1) and includes a front face 16 and a rear face 18. Front and rear faces 16, 18 are shown as being flat, although this is not critical to the invention. The surfaces may be contoured (e.g., concave, convex, grooved, etc.) if desired. Contours may assist in fluid flow around the support element 12. However, as will be explained in greater detail below, support element 12 preferably is shaped and configured so as not to impart lateral movement (such as caused upon rotation of the tip ball against contact element 14) to other parts of point assembly 20.

Contact element 14 of ball pusher 10 extends substantially perpendicularly from front face 16. Contact element 14 has a diameter that is smaller than the diameter of support element 12. This also aids in minimizing the scratching on the tip ball 36 because it reduces the surface area over which the contact element 14 contacts the tip ball 36.

Contact element 14 is preferably designed and configured for contacting the tip ball 36 at the front of point assembly 20 along central longitudinal axis 15 of point assembly 20 and for minimizing scratching of the tip ball 36 as it rotates. Pushing end 52 of contact element 14 may be designed and configured to conform to the shape of the tip ball 36. Also, contact element 14 may extend perpendicularly from a central portion or area 22 of support element 12. The central location of contact element 14 permits contact at a central region of a planar projection of tip ball 36 (i.e., coaxial with longitudinal axis 15 and also aligned with the center of tip ball 36 and thus contacting the uppermost portion of tip ball 36) and may aid in minimizing the scratching on tip ball 36 as lateral forces on tip ball 36 are reduced. When a straight pin formed from a longitudinally extending free end of a coil spring is used, it is more difficult to align the straight pin with a central region of a planar projection of the tip ball because each coil of the spring is concentric with the circumference of the planar projection of the tip ball but is not coaxial with the longitudinal axis 15. Thus, with a coil spring, the straight pin is aligned offset from the center of the tip ball, which imparts lateral forces on the tip ball and causes more scratching on the tip ball.

Because ball pusher 10 is formed separately from biasing element 38, the optimum material may be used for reducing scratching of contact element 14 against tip ball 36. For, instance, different types of material, such as Teflon, polypropylene, and other plastics, metals, glass, or other substances, are believed to be useful for minimizing scratching of contact element 14 against tip ball 36. It is desirable, however, that contact element 14 be capable of providing a low friction surface against which tip ball 36 can rotate by using a material which has a low coefficient of friction versus the material of tip ball 36. When a contact element of a ball pusher is a straight pin formed from a coil spring, there is direct contact between the tip ball and the steel end of the spring, both of which have poor coefficients of friction. Also, a simple helical spring, which may be used with ball pusher 10 of the present invention, is less expensive than a coil spring with a straight pin. Furthermore, due to economic reasons, when a coil spring is used to form a ball pusher, the end of the spring is just cut and not shaped and polished, which increases scratching of the tip ball. Thus, unlike the prior art, utilizing a longitudinally extending portion of a coil spring to push against a tip ball, the optimal materials and shape may be selected for both the ball pusher and the biasing element of the present invention. This is particularly helpful since these elements serve different functions and typically need different optimal materials. The best shape of the ball pusher and biasing element can be dependent on the materials of the tip ball and ball pusher and the properties of the fluid.

In the embodiment of FIG. 1, support element 12 includes four cut-out portions 24. Each cut-out portion 24 extends between the front and rear faces 16, 18 of support element 12 and is sufficiently sized to allow fluid to flow therethrough. The cut-out portions 24 of the embodiment of FIG. 1 are preferably evenly sized and evenly spaced around the periphery 26 of support element 12. This allows for the fluid to flow smoothly and equally through the support element 12. Cut-out portions 24 shown in FIG. 1 are substantially triangular in shape and are evenly spaced around the periphery of support element 12 such that support element 12 is substantially X-shaped or cross-shaped. In this embodiment, the width of the blades (non cut-out portions) of support element 12 thus increases in a radial direction from central area 22 towards periphery 26. In this embodiment, the non cut-out surface of rear face 18 of support element 12 is large enough to provide adequate support for biasing element 38. It should be noted that other shapes, locations, configurations, etc., of cut-out portions may be utilized with the present invention, the invention not being limited to a particular shape, location, configurations, etc., of cut-outs as long as they are large enough to allow for the flow of the fluid. These shapes can include, but are not limited to, circles, wedges, or slots. In addition, fewer than or more than four cut-out portions may be provided. Also, cut-out portions 24 shown in the figures extend from a central area or portion 22 of the support element to and including the periphery 26 of support element 12. The cut-out portions 24 are actually made by removing a portion of the periphery 26 of support element 12. Other types of cut-outs may also be used with the present invention, such as holes that do not extend to periphery 26 of support element 12. Thus, the size, number, and shape of the cut-out portions 24, as well as their position, are not believed to be critical to the present invention. The size, number and shape of the blades (non cut-out portions) of support element, which depend on the size, number and shape of the cut-out portions, may also vary, inasmuch as they are adapted to stabilize the support element and biasing element.

As discussed above, an exemplary housing 30 for the ball pusher 10 is illustrated in FIGS. 2 and 3. Ball pusher 10 is positioned in housing 30 of point assembly 20. Housing 30 includes a tip end 32 and a back end 34. Tip ball 36 is positioned in tip end 32 of point assembly 20. Although tip ball 36 is illustrated as spherical, other shapes are within the scope of the present invention. Tip end 32 of point assembly 20 includes a tip opening 28 through which fluid, such as ink, may flow. Contact element 14 of ball pusher 10 abuts tip ball 36 and biasing element 38 abuts support element 12 of ball pusher 10. Front face 16 of support element 12 faces tip end 32 while rear face 18 of support element 12 faces back end 34 of housing 30. Biasing element 38 is shown as a coil spring in FIGS. 2 and 3, although other types of springs may also be utilized, as known by those of ordinary skill in the art. Biasing element 38 is preferably under tension such that it biases ball pusher 10 toward tip ball 36. Thus, tip ball 36 is biased by biasing element 38, via ball pusher 10, towards tip end 32 to close tip opening 28 and to inhibit undesired fluid flow therethrough. During writing, when tip ball 36 is pressed against a surface, tip ball 36 is also pushed towards ball pusher 10 and biasing element 38 to open a slight gap between tip ball 36 and tip opening 28 to permit the desired amount of fluid flow out of tip opening 28.

As shown in FIG. 2, housing 30 includes an inner barrel 40. Inner barrel 40 has a varied cross-sectional shape that can be divided into at least three portions, including a front portion 42 at tip end 32, a back portion 44 at back end 34, and a middle portion 46 positioned between front and back portions 42, 44. Front portion 42 is configured and dimensioned for receiving tip ball 36. An opening 28 is provided at tip end 32 of front portion 42 and a passageway 49 extends through front portion 42 to meet with a passageway 50 in middle portion 46. Middle portion 46 tapers outwardly toward back portion 44 and thus is substantially outwardly cone-shaped with a narrow section 43 adjacent front portion 42 and a wide section 45 associated with back portion 44. Back portion 44 is substantially cylindrical. Contact element 14 of ball pusher 10 is positioned in middle portion 46 and extends along the longitudinal axis 15 of housing 30 so that pushing end 52 of contact element 14 touches tip ball 36 through passageway 50. Support element 12 of ball pusher 10 is positioned in back portion 44. Support element 12 and cylindrical inner wall 58 of back portion 44 are designed and configured so that periphery 26 of support element 12 provides stability to support element 12 within back portion 44. Support element 12 may be further designed and configured to substantially limit support element 12 to displacement along and rotation about the longitudinal axis of the housing 30 and to reduce significantly, if not to eliminate completely, lateral movement. Thus, any lateral movement of ball pusher 10 preferably is insignificant (i.e., does not adversely affect the functioning or wear of point assembly 20). Biasing element 38 is positioned in back portion 44 and abuts, at one end, rear face 18 of support element 12. Support element 12 does not contact biasing element 38 in the lateral direction. This allows for support element 12 to be configured independent of biasing element 38, thus allowing easier manufacturing of support element 12 and biasing element 38. Back end 60 of biasing element 38 may be positioned against an inwardly projecting abutment in the point assembly (not shown) or may otherwise be secured either within or outside of point assembly 20, the securement of back end 60 of biasing element 38 not being critical to the invention.

While the present invention is discussed in the context of a writing instrument, it should be understood that the present invention is useful with any type of ball-tipped applicator, including any type of applicator that utilizes a ball in the point of the applicator for applying fluid to a surface. In addition, while the present invention is discussed in the context of a writing instrument, it should also be understood that the invention is applicable to other types of applicators for different types of media, such as correction fluid, adhesive, or other substances. Therefore, the invention is not limited to a writing instrument.

Furthermore, while the foregoing description and drawings represent the preferred embodiments of the present invention, it will be understood that various additions, modifications and substitutions may be made therein within the spirit and scope of the present invention. In particular, it will be clear to those skilled in the art that the present invention may be embodied in other specific forms, structures, arrangements, proportions, and with other elements, materials, and components, without departing from the scope of the invention. One skilled in the art will appreciate that the invention may be used with many modifications of structure, arrangement, proportions, materials, and components and otherwise, used in the practice of the invention, which are particularly adapted to specific environments and operative requirements without departing from the scope of the present invention. The presently disclosed embodiments are therefore to be considered in all respects as illustrative and not restrictive.

1. A point assembly for an applicator, comprising:
a housing having a back end and a tip end with a tip opening;
a tip ball positioned in said tip end of said housing and sized to close said tip opening when positioned against said tip opening;
a biasing element positioned to bias said tip ball toward said tip opening; and
a ball pusher positioned between said biasing element and said tip ball and including a support element and a contact element extending from said support element and having a shape adapted to conform to the shape of the tip ball;
wherein:
said support element has a front face and a rear face;
said contact element extends from said front face;
said rear face faces said biasing element;
said support element has a cross-sectional dimension and said contact element has a cross-sectional dimension smaller than said support element cross-sectional dimension; and
said support element does not contact said biasing element in a lateral direction.

2. The point assembly of claim 1, wherein said contact element extends outwardly from a center portion of said front face of said support element.

3. The point assembly of claim 1, wherein:
said housing has an inner barrel having a varied cross-sectional shape;
said inner barrel has at least a front portion, a middle portion, and a back portion;
said front portion is substantially ball-shaped and includes a passageway to said middle portion;
said middle portion is outwardly cone-shaped with a narrow section adjacent said front portion and a wide section associated with said back portion;
said back portion is substantially cylindrical;
said tip ball is positioned in said front portion;
said biasing element and said support element are positioned in said back portion; and
said contact element extends through said middle portion to meet said tip ball positioned in said front portion.

4. The point assembly of claim 3, wherein said support element is configured and dimensioned for insignificant lateral movement within said barrel of the point assembly.

5. The point assembly of claim 1, wherein:
said housing has an inner barrel in which said tip ball, said biasing element, and said ball pusher are positioned;
said support element is substantially cylindrical and said inner barrel has a cylindrical interior wall; and
said support element has a diameter selected to allow said support element to slide within said cylindrical interior wall of said barrel without significant lateral movement.

6. The point assembly of claim 1, wherein said contact element of said ball pusher is formed integrally with said support element of said ball pusher.

7. The point assembly of claim 1, wherein said ball pusher is formed of one of metal, plastic, or glass.

8. The point assembly of claim 1, wherein said ball pusher has a low friction against said tip ball.

9. The point assembly of claim 1, wherein said applicator is a writing instrument.

10. The point assembly of claim 1, wherein said support element includes at least one cut-out portion extending therethrough between said front face and said rear face of said support element for allowing a substance to flow through said cut-out portions for exit through said tip opening.

11. The point assembly of claim 1, wherein said ball pusher is formed separately from said biasing element.

12. The point assembly of claim 1, wherein said biasing element is a helical spring.

13. A ball pusher for positioning in the point assembly of an applicator, said point assembly having a tip opening in which a tip ball is positioned, said tip ball being biased against the tip opening by a biasing element, wherein said ball pusher comprises:
a support element having a front face, a rear face, and a cross-sectional dimension, said rear face of said support element being configured for facing the biasing element in the point assembly of the applicator; and
a contact element extending from said front face of said support element, said contact element being configured for contacting the tip ball and having a shape adapted to conform to the shape of the tip ball positioned at the tip opening and for pushing the tip ball against the tip opening, said contact element having a cross-sectional dimension smaller than said support element cross-sectional dimension;
wherein said support element does not contact said biasing element in a lateral direction.

14. The ball pusher of claim 13, wherein said support element has at least one cut-out portion extending from said front face to said rear face.

15. The ball pusher of claim 13, wherein said contact element is substantially cylindrical.

16. The ball pusher of claim 13, wherein said contact element is formed integrally with said support element.

17. The ball pusher of claim 13, wherein said ball pusher is formed of one of metal, plastic, or glass.

18. The ball pusher of claim 13, wherein said contact element extends from the center of said support element.

19. The ball pusher of claim 13, wherein said contact element is perpendicular to said support element.
